(19) United States
(12) Patent Application Publication
(10) Pub. No.: US 2005/0156345 A1
(43) Pub. Date: Jul. 21, 2005

(54) Vertical moulding of concrete

(75) Inventor: Graeme R Hume, Werribee Victoria (AU)

Correspondence Address: CONNOLLY BOVE LODGE & HUTZ LLP, SUITE 800, 1990 M STREET NW, WASHINGTON, DC, 20036-3425, US

(73) Assignee: Vertech Hume P ty . Ltd., Werribee (AU)

(21) Appl. No.: 10/511,144

(22) PCT Filed: Apr. 23, 2003
(86) PCT No.: PCT/AU03/00481

(30) Foreign Application Priority Data
Apr. 26, 2002 (AU) PS 1953

(51) Int. Cl. B28B 1/26

(52) U.S. Cl. 264/86; 249/175; 264/333

(57) ABSTRACT

A method of moulding long concrete articles in a vertical mould which incorporates a mould liner (17) with drainage tubes (5) used to dewater the concrete when the mould is filled. The improvement is to close off the drainage tubes (5) during the filling of the mould to inhibit water loss in the concrete during filling. The drainage tubes (5) may incorporate one way valves or include inner tubes (15) that may be pressurized to inhibit water entering the drainage tube (5).

This invention relates to improvements in the moulding of concrete articles such as poles, piles or pipes in a vertical mould.

### BACKGROUND TO THE INVENTION

The moulding of concrete pipes, hollow poles or piles in a vertical mould has been proposed in U.S. Pat. No. 4,996,013. The mould is filled from the bottom and the concrete is compressed between an inner and outer mould by moving the inner mould outwardly using a flexible membrane. Water drained from the concrete into drainage galleries or tubes in the membrane. Because water segregates from the concrete during the filling of the mould water tended to accumulate in the upper section of the mould during filling. This problem was addressed in U.S. Pat. No. 6,284,172 by capping the end of the mould to allow egress of fluid but retain particulates and stopping the filling of the mould when the presence of solid materials at the end cap is sensed.

Although these methods produce poles of adequate strength the surface finish of the articles is sometimes rough and cavities form in the surface during stripping of the article from the mould. The dewatering step also appears to proceed unevenly in the moulded product.

It is an object of this invention to overcome these problems and provide a method and apparatus that produces poles, piles or pipes in a vertical mould with an acceptable surface finish.

### BRIEF DESCRIPTION OF THE INVENTION

To this end the present invention provides a method of forming concrete articles in a vertical mould in which the concrete mix is pumped into the mould from the bottom of the mould and the segregation of the water is inhibited to maintain an homogenous viscosity as the concrete mix rises in the mould.

This invention is partly predicated on the discovery that surface defects and uneven dewatering are caused by segregation of the water during pumping of the concrete into the mould. This segregation allows localized regions to develop lower water to cement ratios than for the composition as a whole. It was discovered that segregation occurs because water escapes through the drainage galleries or tubes in the flexible mould liners before the mould is completely filled.

Accordingly the present invention provides a method of moulding long concrete articles in a vertical mould which incorporates a mould liner having drainage tubes used to dewater the concrete when the mould is filled, the improvement being to close off the drainage tubes during the filling of the mould to inhibit water loss in the concrete during filling.

More particularly the present invention provides a method of forming long concrete articles in a vertical mould which includes the steps of
a) providing a mould liner having drainage tubes to allow water to be removed from the wet concrete
b) providing reinforcing in the mould cavity
c) pumping wet concrete into the bottom of the mould under pressure so that the concrete rises to the top of the mould
d) preventing water from leaving the drainage tubes during the step of filling the mould with wet concrete
e) allowing water to drain from the drainage tubes after the mould is filled.

This method is particularly suited for forming poles for use as power poles or street lighting or as piles for construction sites or even for making concrete pipes.

In another aspect this invention provides a vertical mould for forming long concrete articles having
f) an annular mould cavity defined by a core and an outer shell
g) a mould liner around the inner core of the mould cavity which includes vertical drainage tubes incorporating vertically space perforations to allow dewatering of the concrete
h) means associated with said drainage tubes to prevent water leaving said drainage tubes during the filling of the mould cavity

In another aspect the present invention provides a flexible mould liner incorporating drainage tubes to allow dewatering of the concrete wherein the drainage tubes are at least partially closed during the filling of the mould to inhibit water loss and are opened when the mould is filled to allow water to escape.

The closing of the drainage tubes can be achieved in any suitable way. One way valves which prevent water from rising in the drainage tubes to a height not much greater than the level of concrete in the mould can be used. It has been found that one way valves situated at vertical spacings of between 50 and 250 mm are adequate but spacings of 100 mm are preferred.

Another alternative is to use a thin flexible inner tube in side the drainage tubes which inner tube can be pressurized with air or fluid to press against the openings in the drainage tubes to prevent water escaping from the concrete. When the inner tube is depressurized, water can escape to allow dewatering of the concrete in the filled mould.

It is also possible to utilize water pressure from the mould filling to pressurize the inner tube in the drainage tube. This can be done by closing off the upper end of the inner tube or having a one way valve at that end and having a drainage cock at the lower end. This means a slightly greater pressure is need to lift the concrete and some water loss occurs but the homogenous viscosity of the concrete is maintained.

### DETAILED DESCRIPTION OF THE INVENTION

Preferred embodiment of the invention is described with reference to the drawings in which:

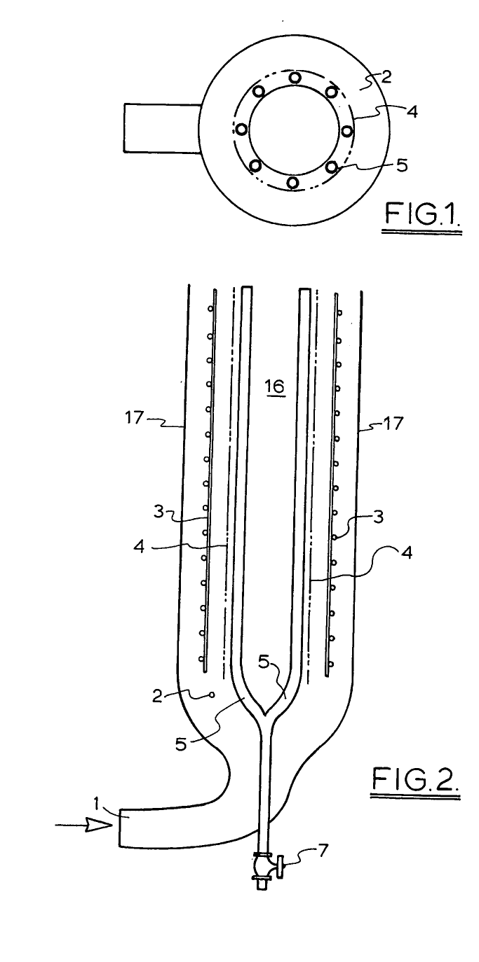

FIGS. 1 (plan view) and 2 (cross section) is a schematic illustration of the mould and mould liners utilizing the drainage tubes of this invention;

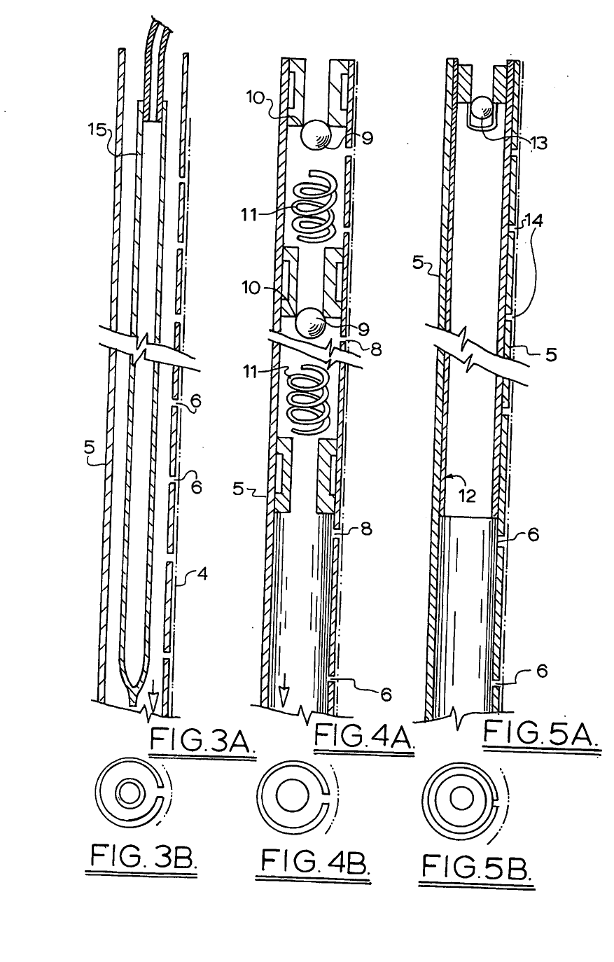

FIGS. 3A (cross section) and 3B (plan view) is a schematic illustration of a first embodiment of the drainage tube of this invention;

FIGS. 4A (cross section) and 4B (plan view) is a schematic illustration of a second embodiment of the drainage tube of this invention;

FIGS. 5A (cross section) and 5B (plan view) is a schematic illustration of a third embodiment of the drainage tube of this invention;

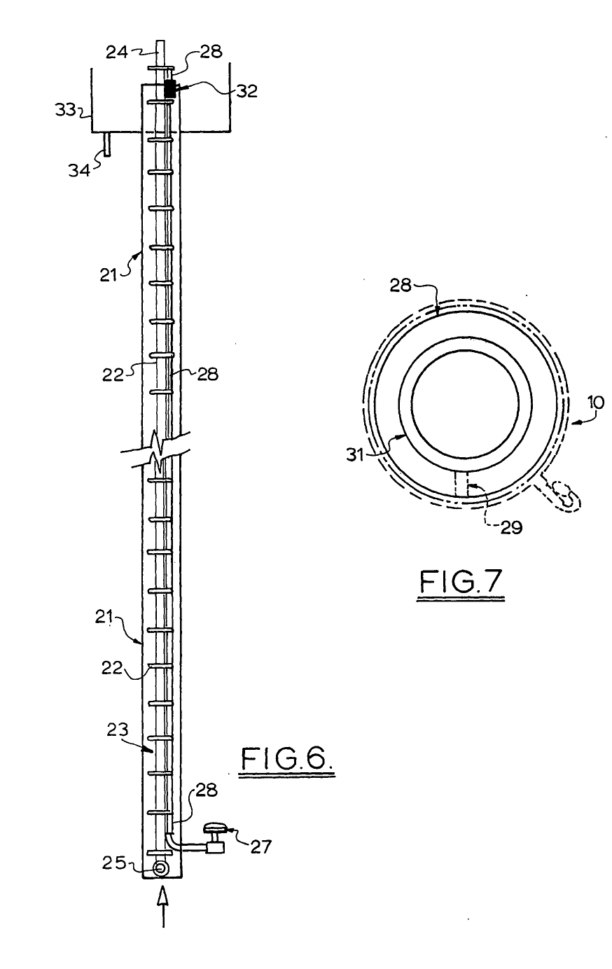

FIGS. 6 (cross section) and 7 (plan view) illustrate a test rig used to determine the effectiveness of the water control method of this invention.

The vertical mould for forming concrete poles is of the kind described in U.S. Pat. No. 6,284,172 the contents of which are incorporated herein by reference. The difference is that the drainage tubes in the filter media of the mould liner are modified in accordance with this invention. The mould is usually 12.5 metres high and concrete in a water/cement ration of about 0.45 is pumped into the bottom of the mould. Once the concrete comes into contact with the filter media water begins to bleed into the drainage holes which are usually spaced at 50 mm centres. The pressure required to raise the concrete 12.5 metres is approximately 830 kPa but varies with the water to cement ratio, the aggregate used and the complexity of the reinforcing in the mould cavity; whereas the pressure of a 12.5 metre head of water is approximately 138 kPa with the result that the water is forced into the drainage tubes. The water loss is usually not homogenous and some portions of the concrete lose more water than others.

To control and inhibit this water loss the drainage tubes of this invention are used. As shown in FIGS. 1 and 2 the mould cavity 2 is defined by the inner core 16 and outer mould liner 17 and includes a reinforcing cage of steel 3 around which the concrete is pumped. As the concrete enters the mould 2 the water passes through the filter 4 and then into the drainage tube 5 via the drainage holes 6. The drainage cock 7 is closed so that the water rises up the tube 5.

In FIGS. 3A and B a first embodiment uses nylon drainage tubes 5 incorporated into the filter media 4 which have drainage holes 6 at 50 mm centres. Inside the drainage tube 5 is a silicon tube 15 which is able to be filled with water or air under pressure to seal against the holes 6 in the tube 5. The fluid is introduced into the inner tube 15 via the inlet 16 and the remote end 17 is sealed or tied.

An alternative arrangement is shown in FIG. 2 where the drainage tube 5 includes non return valves spaced vertically 100 mm apart. The non return valves may consist of a valve seat comprising an annular brass valve seat 10 glued to the internal wall of the drainage tube 5 and a floating ball 9 adapted to seal against the valve seat and supported on a helical support 11 which in turn is supported on the upper face of the valve seat located 100 mm below.

As concrete rises in the mould water enters the drainage tube and because the drainage cock 7 [FIG. 4] is closed the water rises vertically in the drainage tube 5. Initially water will rise to drain hole 8 and some will escape into the mould space until the concrete reaches the level of hole 8. the water rising in the drainage tube 5 will press the ball 9 against valve seat 10 and prevent further water entering the drainage tube 5 until the concrete level rises to the level of the drainage hole immediately above the valve seat 10. In this way the water loss from the concrete is limited to the volume of the drainage tubes in the 100 mm rise of the mould between valve seats. When the mould is filled the drainage cock 7 is opened and the dewatering procedure as outlined in U.S. Pat. No. 6,284,172 is followed.

A further embodiment is illustrated in FIGS. 5A and B. Inside the drainage tube 5 is an inner tube 12 which has a non return, floating ball valve 13 at its upper end adjacent the top of the mould cavity. As water rises in the tube 12 it pushes out the air and when the water reaches the non return valve the valve is closed and the pressure inside tube 12 increases. The water level in the tube 12 is always higher than the concrete level in the mould cavity and the higher pressure in the tube 12 presses the tube 12 against the drainage tube and prevents water entering the tube 5 through the drain holes 14. When the mould cavity 2 is filled the drain cock 7 is opened and the water in tube 12 flows out. When the dewatering procedure commences the pressure of the water in the mould is greater than the pressure within the empty drain tube 12 so that it collapses and allows water to enter tube 5 through the holes 14 and drain away.

A test facility illustrating the effectiveness of one embodiment of this invention is shown in FIGS. 6 and 7. The test method was devised to generate similar pump pressures and conditions to those experienced in filling a vertical mould about 12 metres high. Because of the restrictions caused by the presence of the reinforcing cage in the mould space the pressure rises to about 830 Kpa.

Tha apparatus was set up using a 12 metre long plastic PVC pipe 21 to simulate a mould cavity. The reinforcing cage 22 consisting of a series of rings 23 fixed to a vertical rod 24 was inserted into the pipe 21 and held in position by the ring 25. The drainage tube 28 consists of a nylon tube extending the full height of pipe 21 and is arranged within the rings 23 of the cage 22. The drainage tube 28 is approximately 6 mm in internal diameter with 1 mm holes 29 at 50 mm spacings along its full length. A valve 27 is fitted at the lower end of tube 28. A filter media 30 is wrapped around the tube 28 to prevent cement particles from entering the drainage tube 28 through holes 29. Fitted neatly within the drainage tube 28 is a silicon rubber tube 31 of external diameter of about 6 mm and internal diameter 4 mm. the tube 31 extends from the top of drainage tube 28 and finishes about 500 mm above the bottom of the pipe 21. At the upper end of the drainage tube 28 and inner tube 31 is a one way valve 32. A water trap 33 is arranged at the top of the pipe 21 with an out let 34.

After initially spraying water down the pipe 21 concrete is pumped in at the lower end of pipe 21. Immediately the concrete reaches the filter media 30 about the drainage tube 28 the pressure exerted by pumping causes water to pass through the holes 29 into the lower end of the silicon tube 31. The water level in the drainage tube 28 rises more quickly in than the level of the concrete in the pipe 21 due to its lower specific gravity. At 117 Kpa which is the pressure equivalent to the head of water in the 12 metre high tube 28 the water reaches the one way valve 32 and closes it. The water pressure within the silicon tube 31 closes the holes 29 in the drainage tube 28 so that no more water can be separated from the concrete. The concrete rises to the top of pipe 21 without showing signs of any segregation because the water loss is equal to the internal volume of the silicon tube 31 about 150 cc.

Following this test the concrete was withdrawn from pipe 21 and returned to the pump. The tube 31 was then removed from the drainage tube 28. the pipe 21 and drainage tube 28 were flushed clean with water. The same concrete was pumped into the pipe 21. This time the water passing through the filter 30 and holes 29 rises up the drainage tube to the next spaced hole 29 and flows back onto the top of the concrete column. This water is unable to remix with the concrete and remains segregated. As the concrete approaches the top of pipe 21 the water on top of the concrete column overflows into the water trap 33 and is collected from outlet 34. The quantity of water lost was measured at 5000 cc. This test demonstrates that the control of water entering the drainage tube during the filling of the mould maintains the homogeneity of the concrete and prevents water segregation with its consequential problems of uneven dewatering and cracked product when cured.

Those skilled in the art of moulding concrete articles will realize that the present invention can be put into effect by a variety of means to inhibit water escaping the mould cavity during the filling of the mould cavity as well as the methods and arrangements disclosed herein.

1. A method of forming concrete articles in a vertical mould in which the concrete mix is pumped into the mould from the bottom of the mould and the segregation of the water is inhibited to maintain an homogenous viscosity as the concrete mix rises in the mould.

2. A method of forming long concrete articles in a vertical mould which includes the steps of
a) providing a mould liner having drainage tubes to allow water to be removed from the wet concrete
b) providing reinforcing in the mould cavity
c) pumping wet concrete into the bottom of the mould under pressure so that the concrete rises to the top of the mould
d) preventing water from leaving the drainage tubes during the step of filling the mould with wet concrete
e) allowing water to drain from the drainage tubes after the mould is filled.

3. A vertical mould for forming long concrete articles having
a) an annular mould cavity defined by a core and an outer shell
b) a mould liner around the inner core of the mould cavity which includes vertical drainage tubes incorporating vertically space perforations to allow dewatering of the concrete
c) means associated with said drainage tubes to prevent water leaving said drainage tubes during the filling of the mould cavity

4. A mould as claimed in claim 3 in which the drainage tubes incorporate an inner tube that is able to be pressurized to close off the perforations in the walls of the drainage tube.

5. A mould liner as claimed in claim 3 in which the drainage tubes incorporate one way valves vertically spaced apart in the drainage tube.

6. A flexible mould liner for use in the mould of claim 3 which incorporates drainage tubes to allow dewatering of the concrete wherein the drainage tubes are capable of at least partially being closed during the filling of the mould to inhibit water loss and are opened when the mould is filled.

7. A mould liner as claimed in claim 6 in which the drainage tubes incorporate an inner tube that is able to be pressurized to close off the drainage holes in the walls of the drainage tube.

8. A mould liner as claimed in claim 6 in which the drainage tubes incorporate one way valves vertically spaced apart in the drainage tube.

9. Long concrete articles formed by the process of claim 1 or 2.
